(19) United States
(12) Patent Application Publication
(10) Pub. No.: US 2006/0224964 A1
(43) Pub. Date: Oct. 5, 2006

(54) Method, apparatus, and system of displaying personal digital media according to display characteristics

(75) Inventors: Jordan L.K. Schwartz, Seattle, WA (US); Christopher A. Evans, Sammamish, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/093,921

(22) Filed: Mar. 30, 2005

(51) Int. Cl. G06F 9/00

(52) U.S. Cl. 715/730

(57) ABSTRACT

A method and apparatus for displaying media describe automatically processing metadata of each of a plurality of shared media objects to determine a display characteristic, and automatically displaying each of the plurality of shared media objects according to its display characteristic. A system for displaying media describes a media library to store a plurality of shared media objects and metadata of each of the plurality of shared media objects, a processor to automatically determine a display characteristic based on the metadata of each of the plurality of shared media objects, and a passive media display apparatus to automatically display each of the plurality of shared media objects according to its display characteristic. The display characteristic may be order, duration, frequency, transition, and effect.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present invention relates to digital media. More particularly, the present invention relates to the display of personal digital media according to display characteristics that are determined based on metadata of the personal digital media.

### BACKGROUND OF THE INVENTION

Personal digital media such as photos and video are an important part of the consumer digital ecosystem. A number of solutions have been developed to allow enjoyment and consumption of such media, ranging from dedicated PC-based software applications such as the Microsoft® Digital Image Suite and PICASA (by Google) slideshow to dedicated hardware devices, such as the Microsoft® Media Center PC (including Windows Media® Center Edition), the iPod photo, Portable Media Centers (hardware manufactured to Microsoft specifications and running Microsoft® software, e.g., Creative Zen Portable Media Center, Samsung Yepp YH-999, etc.), and digital photo frames such as Pacific Digital's MEMORYFRAME.

In the last category, i.e., digital photo frames, the solutions tend to be simple display devices with little intelligence attached. As a result, the display of personal digital media in dedicated photo frames tends to be very simplistic, and as a result, not as enjoyable. For example, the wrong pictures are displayed at the wrong time, video cannot be displayed, the presentation lacks aesthetic value, etc. Further, while image slide shows are well known in the art, they are typically implemented in such a way that the display is not performed intelligently. For example, the user must set display characteristics such as transition, and the order of display is either totally random or in order without regard to the subjective value of each image.

Therefore, what is needed is a way to automatically determine display characteristics of media objects such as order, duration, frequency, transition, and effect based upon metadata of the media objects. What is also needed is a way to automatically display the media objects according to those display characteristics.

### SUMMARY OF THE INVENTION

The present invention describes a method of displaying media. Metadata of each of a plurality of shared media objects is automatically processed to determine a display characteristic of each of the plurality of shared media objects. Each of the plurality of shared media objects is automatically displayed according to its display characteristic. The display characteristic is one of order, duration, frequency, transition, and effect.

The present invention also describes a media display apparatus. A processing module automatically determines a display characteristic of each of a plurality of shared media objects based on metadata of each of the plurality of shared media objects. A display module automatically displays each of the plurality of shared media objects according to its display characteristic. The display characteristic is one of order, duration, frequency, transition, and effect.

The present invention further describes a system for displaying media. A media library stores a plurality of shared media objects and metadata of each of the plurality of shared media objects. A processor automatically determines a display characteristic of each of the plurality of shared media objects based on the metadata of each of the plurality of shared media objects. A passive media display apparatus automatically displays each of the plurality of shared media objects according to its display characteristic. The display characteristic is one of order, duration, frequency, transition, and effect.

### BRIEF DESCRIPTION OF THE SEVERAL VIEWS OF THE DRAWINGS

The present invention is described in detail below with reference to the attached drawing figures, wherein:

FIG. 1 is a block diagram of a computing system environment suitable for use in implementing the present invention;

FIG. 2 is a diagram illustrating the flow of media objects and reviews/comments between owner and user, according to embodiments of the present invention;

FIG. 3 is a diagram illustrating the determination of display characteristics, according to embodiments of the present invention;

FIG. 4 is a diagram illustrating a media display apparatus, according to embodiments of the present invention;

FIG. 5 is a flowchart illustrating the display of media objects and the receipt of reviews/comments, according to embodiments of the present invention; and

FIG. 6 is a diagram illustrating a system including a passive display apparatus, according to embodiments of the present invention.

### DETAILED DESCRIPTION OF THE INVENTION

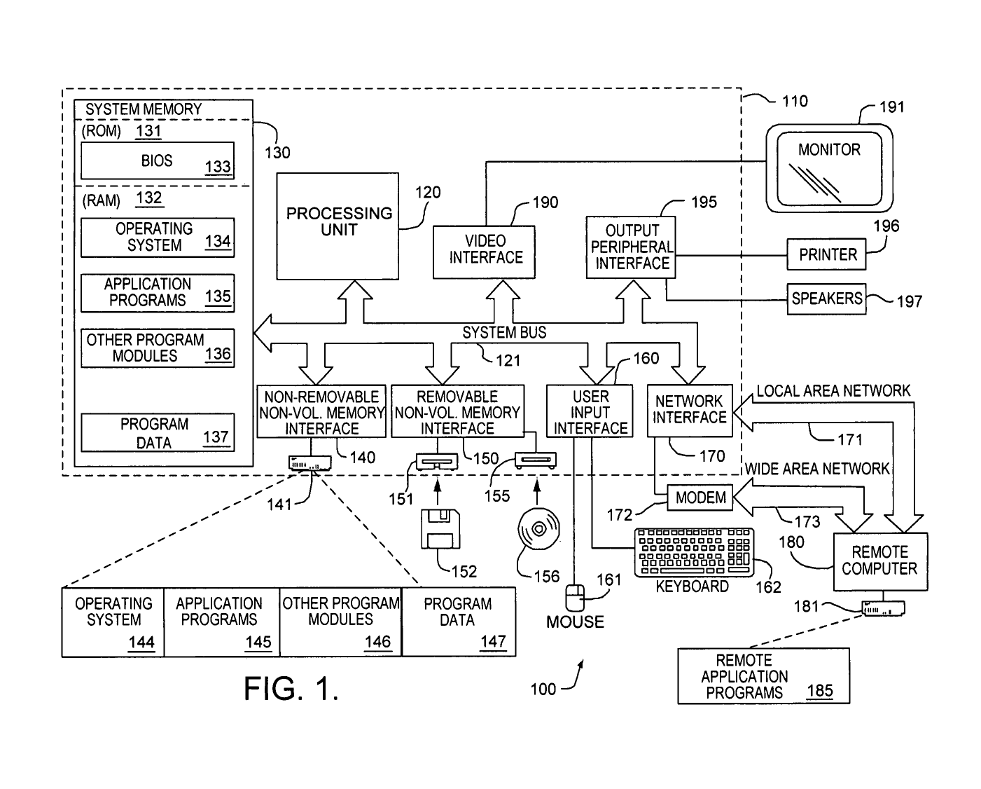

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Interconnect (PCI) bus also know as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable medial may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently begin operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drive and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different number here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and. Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user network interface 170, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

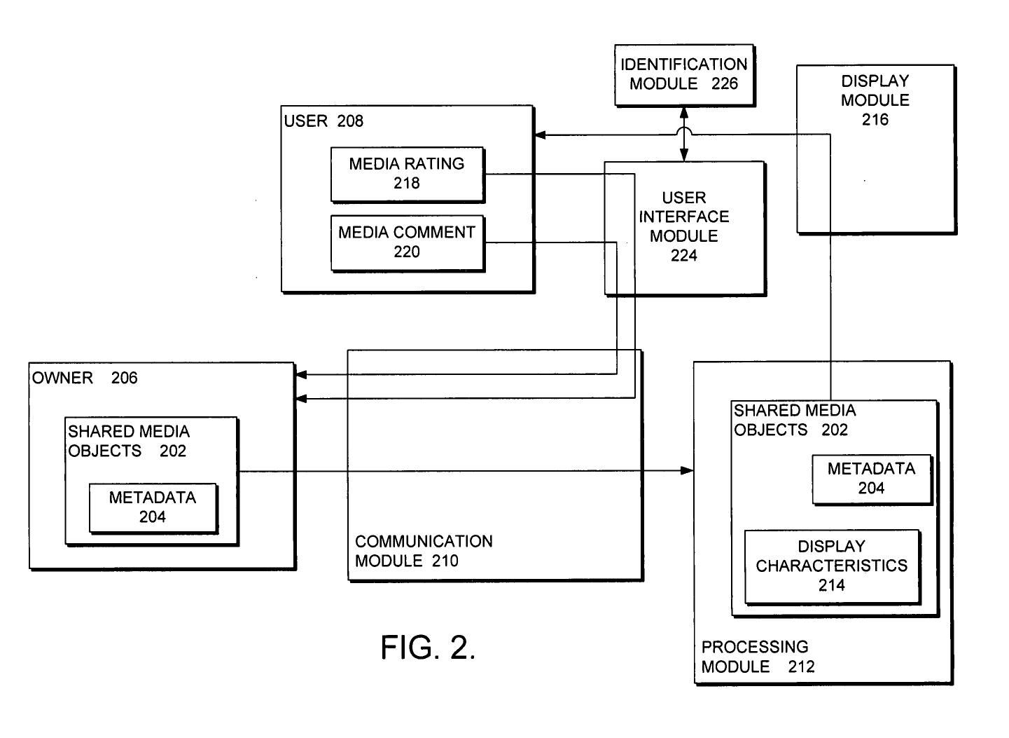

FIG. 2 is a diagram illustrating the flow of media objects and reviews/comments between owner and user, according to embodiments of the present invention. With reference to FIG. 2, a plurality of shared media objects 202, each with corresponding metadata 204, are illustrated as being associated with owner 206. Shared media objects 202 are digital photos, videos, images (e.g., artwork created using an application such as ADOBE PHOTOSHOP), etc. In an embodiment, owner 206 is a person or entity who created shared media objects 202. In another embodiment, owner 206 is a person or entity who merely possesses shared media objects 202. In a further embodiment, owner 206 created some of shared media objects 202 and merely possesses others of shared media objects 202. Embodiments of the present invention are not limited to any specific owner.

Each shared media object has corresponding metadata 204 associated therewith. In an embodiment, metadata 204 comprises an average user rating (local or global), a creation date, a creation time, and a keyword(s); however, metadata 204 are not limited thereto, as other metadata contents are possible. For example, a photo may have an average user rating of 3 out of 5, a creation date of Sep. 12, 2003, a creation time of 5:45 p.m., and keywords of “Sally” and “Brian's wedding”. Of course, an infinite number of possible combinations of metadata 204 are possible for each shared media object. Also, each shared media object may have a different set of metadata 204. For example, one video may have a creation date, creation time, and average user rating, while another video may have only a single keyword. Embodiments of the present invention are not limited to any particular combination of metadata 204 or any number of shared media objects 202. Further, in an embodiment, metadata 204 may have been set or adjusted by owner 206. For example, owner 206 may add the keyword “Paris” to a particular photo that owner 206 took while vacationing in Paris, France. In another example, owner 206 may edit a keyword associated with a video from “fiancée” to “spouse” if owner 206 gets married. In yet another example, owner 206 may adjust the creation date of a photo from “Jan. 1, 1998” to “Mar. 13, 2004” after realizing that the date on owner 206's camera was set improperly.

While shared media objects 202 are illustrated in FIG. 2 as encompassing metadata 204, this is just to indicate association. Various methods of association are envisioned by the present invention, which is not limited to any particular manner of association. For example, metadata 204 may be stored as a watermark on an associated shared media object, they may be stored completely separately from shared media objects 202, they may be stored as a header/footer on an associated shared media object, etc. Someone of ordinary skill in the art will recognize the various methods of associating metadata 204 with shared media objects 202.

While not illustrated in FIG. 2, owner 206 may store shared media objects 202 locally, e.g., in a media library, or remotely, e.g., on a web server. Embodiments of the present invention are not limited to any particular method or location of storage. At some point, owner 206 has designated shared media objects 202 as available for sharing. This can be accomplished by sharing a folder that contains shared media objects 202, designating individual media objects for sharing, copying media objects to a portable memory device (e.g., flash card, USB storage device, etc.), transferring media objects (e.g. via a network connection), etc. Someone of ordinary skill in the art will recognize the various ways in which media objects may be shared, and the present invention is not limited to any particular manner of sharing.

In various embodiments, processing module 212 may be local to owner 206, e.g., on owner 206's computer, or remote, e.g., on a web server or digital media frame. When shared media objects 202 have been designated for sharing, processing module 212 has access thereto. In an embodiment, the access is direct and continuous, e.g., via a network connection. In another embodiment, the access is indirect and sporadic, e.g., via portable flash memory device. Someone of ordinary skill in the art will recognize the various ways in which processing module 212 may have access to shared media objects 202, and the present invention is not limited to any particular manner of access.

Communication module 210 is an input/output device. For example, communication module 210 may comprise a USB or serial port, a wireless networking device, a flash memory device reader/writer, a floppy disk drive, etc. In an embodiment, processing module 212 accesses shared media objects 202 via communication module 210. In another embodiment (not illustrated in FIG. 2), processing module 212 does not access shared media objects 202 via communication module 210.

Processing module 212 determines at least one display characteristic 214 for each of the shared media objects 202 based on the metadata 204. In an embodiment, display characteristics 214 comprise order, duration, frequency, transition, and effect; however, display characteristics 214 are not limited thereto, as other display characteristics are possible. Embodiments of the present invention are not limited to any particular number or set of display characteristics. Processing module 212 is aware of the current date and time for comparison to creation date and creation time.

While shared media objects 202 are illustrated in FIG. 2 as encompassing display characteristics 214, this is just to indicate association. Various methods of association are envisioned by the present invention, which is not limited to any particular manner of association. As with metadata 204 (discussed above), someone of ordinary skill in the art will recognize the various methods of associating display characteristics 214 with shared media objects 202.

Display characteristics 214 are determined based on a weighting system, using metadata 204. In an embodiment, the weighting system is user-determinable; however, in another embodiment, the weighting system is fixed. The weighting system is designed to present shared media objects 202 to user 208 in a manner that improves upon the standard slide show technique that is well-known in the art.

For example, in the well-known slide show technique, if shared media objects 202 include photos A, B, C, and D, photo A may be displayed to user 208 first, for ten seconds, with a hard, instant transition, i.e., no fading. Photo B may then be displayed to user 208 next, for ten seconds, with a hard, instant transition. Photo C may then be displayed to user 208 third, for ten seconds, with a hard, instant transition. Photo D may then be displayed to user 208 last, for ten seconds, with a hard, instant transition. When photo D is finished being displayed, photo A is displayed again, then photo B, then photo C, then photo D, all in the same manner. Photos A-D are continuously cycled through display in a “dumb” fashion, i.e., without regard to the contents of each photo, without regard to the relative appeal of each photo, etc. Of course, user 208 may be able to advance the photos manually before the ten seconds expires, manually adjust the order or set them to be displayed randomly, choose a different transition, e.g., fade in/out, but those settings would have to be applied to all of the photos. So, if user 208 changed the duration of display to six seconds instead of ten seconds, all of the photos would be displayed for six seconds each. If the user randomized the display of the photos, each photo would have an equal chance of being selected to appear next. User 208 may even be able to advance a particular photo manually before the allotted duration expired if he did not particularly like the photo, but user 208 would have to advance the same photo manually before the allotted duration expired each time the photo appeared.

In the present invention, the weighting system allows for a more dynamic, intelligent, and user-friendly presentation of shared media objects 202 to user 208. In an example of the application of a weighting system to the determination of display characteristics 214 for one of the shared media objects 202, the shared media object is initially assigned 10 ‘points’ by processing module 212. If creation date is part of metadata 204 and the shared media object was created within the past five days, it has 20 points added. If it was created within the past two weeks, it has 10 points added. If it was created within the past month, it has 5 points added if average user rating is part of metadata 204 and the shared media object has an average user rating of five out of five stars (five stars being the highest rating), it has 10 points added. If it has an average user rating of four out of five stars, it has 5 points added. If it has an average user rating of three out of five stars, no points are added. If it has an average user rating of two out of five stars, it has 5 points subtracted. If it has an average user rating of one out of five stars, it has 10 points subtracted.

Embodiments of the present invention are not limited to any particular numbers of points added/subtracted, any particular number or hierarchy of ranking indicia, or any particular criteria (e.g., past five days, past two weeks, etc.). Someone of ordinary skill in the art would understand that the present invention could be implemented in several different ways. For example, the rankings could simply be numbers instead of stars. In another example, the ranking could be based on ten possibilities, with 1 being the highest ranking. In yet another example, points could be subtracted or added in the opposite manner. In a further example, the creation dates could be compared to different periods, e.g., one day, two days, three days, etc. In another example, creation time is considered in a similar manner. In yet another example, keywords are considered for particular matches that may yield points. In another example, processing module 212 is aware of people's birthdays, and points are added if a keyword matches or resembles a current or approaching birthday. In a further example, processing module 212 is aware of the current season, and points are added if a keyword matches or resembles the current season. In yet another example, processing module 212 is aware of floating holidays, e.g., Thanksgiving, and the current date, and points are added if a keyword matches or resembles a particular holiday on that date. In another example, processing module 212 is aware of particular goals of user 208, e.g., to lose weight. In such an example, processing module is aware of the current time and user 208's normal or scheduled meal times, and adds points if a keyword indicates that a svelte figure is pictured, as a reminder not to overindulge. In a further example, processing module 212 is aware of other extrinsic data, e.g., current events. In such an example, when a disaster has occurred, processing module 212 adds points if a keyword indicates a somber mood, and subtracts points if a keyword indicates an exuberant mood. In yet another example, points are not even used, as any other way of assigning weights may be used. Points are discussed herein only for the sake of consistency throughout the examples provided.

After each of the shared media objects 202 is weighted based on its metadata, its display characteristics 214 are determined based on the weighting. In one embodiment, a higher number weight is considered to be a higher priority than a lower number weight, e.g., 15 beats 5. However, embodiments of the present invention are not limited to any particular hierarchy of points, as a lower number may be considered to have a higher priority. Based on the relative hierarchy of the weighted shared media objects 202, display characteristics 214 are set accordingly. For example, the shared media object with the highest priority will have its display characteristics 214 set to be displayed first (order), for 20 seconds (duration), and twice as often as the next lower priority shared media object (frequency). The shared media object with the second highest priority will have its display characteristics 214 set to be displayed second, for 15 seconds, and half as often as the highest priority shared media object and three times as often as the next lower priority shared media object. Obviously, someone of ordinary skill in the art would read the present invention and understand that an infinite number of possible display characteristic 214 settings are possible, and the present invention is not limited to any particular set thereof. For example, the highest priority shared media object may be assigned display characteristics 214 that yield a display order starting in the middle, for 32 seconds, and six times as often as the fourth highest ranked shared media object.

In an embodiment, all of the contents of metadata 204 are used to determine display characteristics 214. In another embodiment, less than all of the contents of metadata 204 are used to determine display characteristics 214. User 208 may perform some action to indicate that different metadata 204 should be used. For example, if a photo of a person is being displayed, and if the photo has metadata 204 identifying the person, and if user 208 selects the face of the person in the photo, the present invention may automatically determine display characteristics 214 of shared media objects 202 to display other photos of the person. Further with the above example, if the displayed photo has metadata 204 identifying the setting, e.g., Munich, Africa, John's birthday party, etc., and if user 208 selects the background of the photo, the present invention may automatically determine display characteristics 214 of shared media objects 202 to display other photos of that setting.

When all of the display characteristics 214 have been assigned, each of the shared media objects 202 are displayed to the user according to its display characteristics 214. In an embodiment, display module 216 comprises a display and is used to facilitate the visual presentation to user 208. Embodiments of the present invention are not limited to any particular type of display. For example, the display may be a digital media frame, plasma monitor, CRT monitor, LCD monitor, television, projector, cellular phone display, portable music player display, wristwatch display, pager display, portable email device display, etc. In an embodiment, some or all of metadata 204 corresponding to a particular shared media object are displayed with the shared media object.

In an embodiment, user interface module 224 provides user 208 with the ability to interact with the display of shared media objects 202. For example, user interface module 224 may implement hard (physical) or soft (virtual) buttons on the display for user 208 to provide feedback. In another embodiment, user interface module 224 may implement a separate device, such as a small box with buttons, for user 208 to provide feedback. Someone of ordinary skill in the art will understand the various ways in which interaction between user 208 and the displayed shared media objects 202 may be implemented. The present invention is not limited to any particular implementation.

Upon viewing each of the displayed shared media objects 202, user 208 may provide media rating 218 or media comment 220 or both. In an embodiment, media rating 218 is user 208's subjective assessment of the shared media object currently being displayed or recently displayed. For example, user 208 may assign a displayed media object a rating of 4 stars out of a possible five stars. In another example, user 208 may assign a recently displayed media object a rating of 2 out of 10 points. Embodiments of the present invention are not limited to any particular rating system, i.e., stars, points, etc. In an embodiment, media comment 220 is user 208's subjective commentary on the shared media object currently being displayed or recently displayed. For example, user 208 may input “Great picture!” as media comment 220. In another example, user 208 may record an audio commentary that exclaims “Wonderful video! Do you have more?” Embodiments of the present invention are not limited to any commentary structure.

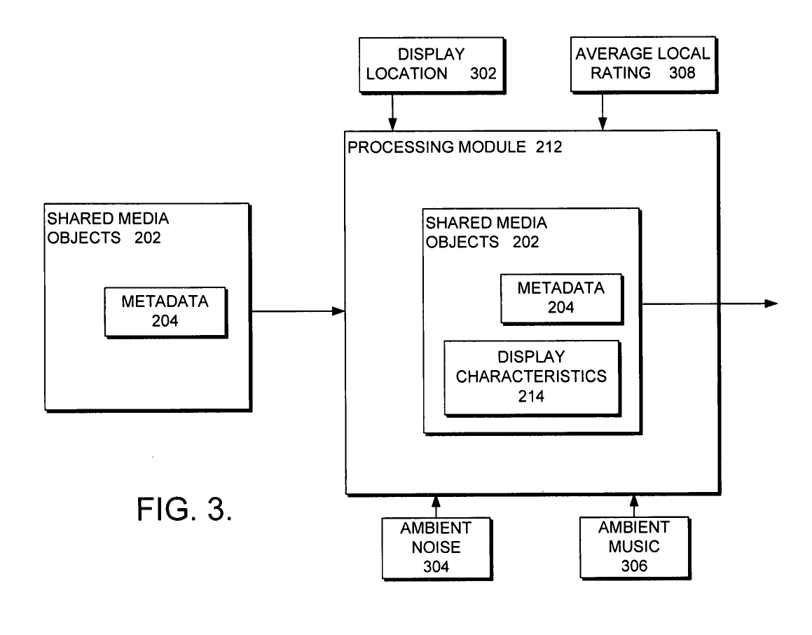

In an embodiment, media rating 218 may be retained locally and aggregated with other ratings, so as to form an average local rating (illustrated in FIG. 3). For example, if several users view a shared media object on a particular display, their average rating may be used by processing module 212 as one of the metadata in determining display characteristics 214.

In an embodiment, identification module 226 works with user interface module 224 to identify user 208 such that user 208's media rating 218 and media comment 220 can be associated with him specifically. In one example, identification module 226 may require user 208 to login to user interface module 224 before providing media rating 218 and media comment 220. In another example, identification module 226 may require user 208 to insert a key card device into a key card reader before providing media rating 218 and media comment 220. Someone of ordinary skill in the art would understand the various ways in which user 208 may be specifically identified. The present invention is not limited to any particular identification implementation.

When media rating 218 or media comment 220 are given by user 208, they may optionally be transmitted to owner 206, or owner 206 may optionally simply be notified of their existence, via user interface module 224 and communication module 210. This allows owner 206 to consider the reviews and comments received from many different users and take them into account when creating or sharing additional media objects. Media rating 218 or media comment 220 may be transmitted via any well-known method of transferring files. Notification of media rating 218 or media comment 220 may be accomplished via any well-known method of sending a message, e.g., email, instant message, computer-automated voicemail, etc. In an embodiment, metadata 204 may be updated in light of media rating 218. For example, if average user rating is included in metadata 204 and it is 5 out of 5 stars based on one user rating, it may be updated to an average of 3 out of 5 stars to reflect a subsequent user rating of 1 out of 5 stars. If owner 206 is remote from user interface module 224 and there is not a constant network connection, user interface module 224 retains any communications until a situation occurs in which communication is possible, e.g., a network connection becomes available, a flash memory device is inserted, a Bluetooth connection goes active, etc.

FIG. 3 is a diagram illustrating the determination of display characteristics, according to embodiments of the present invention. With reference to FIG. 3, the determination of display characteristics 214 is illustrated in slightly greater detail than in FIG. 2. As discussed above, display characteristics 214 are determined based on metadata 204 of shared media objects 202. In addition, in an embodiment, display location 302, ambient noise 304, ambient music 306, or average local rating 308 (illustrated separately from metadata 204 for discussion purposes only) may also be used to determine display characteristics 214.

Display location 302 is the location of the display on which shared media objects 202 are presented to user 208. For example, the location may be a living room, a hallway, a kitchen, a city, a set of longitude/latitude coordinates, etc. However, the present invention is not limited to any particular set of locations, as the display may be located anywhere. When determining display characteristics 214 based additionally on display location 302, processing module 212 examines keywords in metadata 204 for any relevant themes. For instance, processing module 312 may search for keywords such as “living room” when display location 302 is the living room. That way, processing module 212 is able to assign display characteristics 214 in such a way so as to cause certain of shared media objects 202 to be displayed at a higher priority when they are relevant to the location of the display. In an embodiment, display location 302 is entered by user 208 via user interface module 224. In another embodiment, display location 302 is determined by a GPS device. In yet another embodiment, display location 302 may be determined by cellular network triangulation. However, embodiments of the present invention are not limited to any particular method of determining location, as any method may be used. Average local rating 308 is the average local rating as discussed with regard to media rating 218.

Ambient noise 304 is the level of ambient noise in the area of the display. Ambient noise 304 is measured by some sort of sound input device, such as a microphone. However, any sound input implementation may be used in the present invention. In an embodiment, ambient noise 304 is measured in decibels; however embodiments of the present invention are not so limited, as any scale of measurement may be used. Ambient music 306 is ambient music in the area of the display. For example, ambient music 306 may be a song playing in the background on a separate stereo system, or it may be a song playing on a PC connected to the display. Embodiments of the present invention are not limited to any particular source of sound. Ambient music 306 may be measured in the same manner as ambient noise 304. In addition, ambient music 306 may be measured in terms of musical style. For example, reggae music has a different acoustical signature than classical music. Processing module 212 may determine display characteristics 214 based additionally on ambient noise 304 or ambient music 306. In an embodiment, processing module 212 may evaluate the decibel level of ambient noise 304 as being very high, e.g., during a loud party, and set display characteristics 214 of shared media objects 202 such that the duration is very small, e.g., to cycle the media objects rapidly, and such that the effect is aggressive, e.g., MTV-style flashing. In another embodiment, processing module 212 may evaluate the beats per minute of ambient music 306 as being very low, e.g., classical music, and set the display characteristics 214 of shared media objects 202 to transition in and out in a soft manner, e.g., fade in/out slowly, and such that the effect is soft, e.g., sepia tone. Obviously, someone skilled in the art could envision many different ways in which display characteristics 214 could relate to ambient noise 304 or ambient music 306, and the present invention is not limited to any particular relationship.

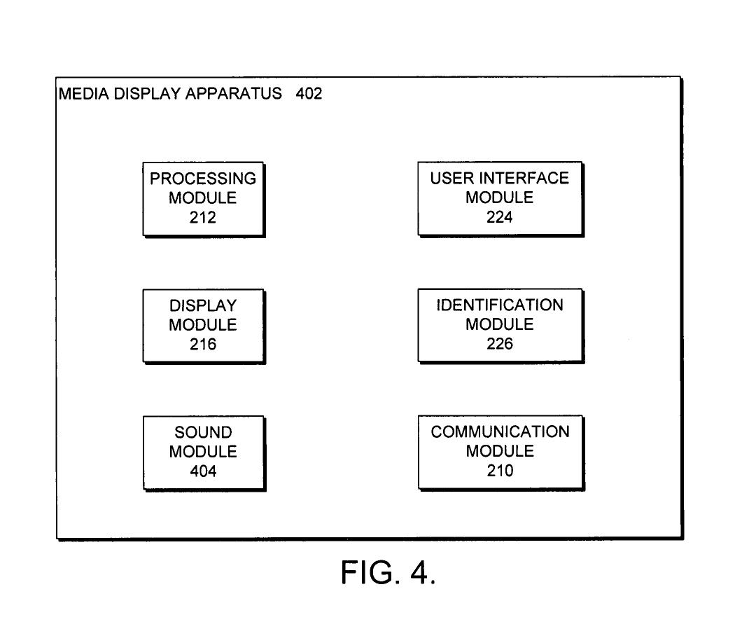

FIG. 4 is a diagram illustrating a media display apparatus, according to embodiments of the present invention. With reference to FIG. 4, media display apparatus 402 is illustrated, which comprises processing module 212, display module 216, user interface module 224, identification module 226, and communication module 210, all of which were discussed in connection with FIG. 2 (above). In addition, in an embodiment, media display apparatus 402 comprises sound module 404. Media display apparatus 402 is a self-sufficient media display apparatus in which all processing, display, user interface, identification, and communication functions are resident in a single unit. For example, media display apparatus 402 may be a digital media frame that comprises the modules illustrated in FIG. 4. Media display apparatus 402 differs from existing digital media frames because processing module 212, which assigns display characteristics 214, is resident thereon.

In an embodiment, sound module 404 plays music for the enjoyment of user 208. For example, media display apparatus 402 may be a portable music player that has the additional capability of determining display characteristics 214 and displaying shared media objects 202 according to the display characteristics 214. In another embodiment, sound module 404 plays sound effects, e.g., a roaring ocean, chirping birds, etc. Sound playback is well-known in the art, and may be implemented in a number of ways, all of which are known to someone of ordinary skill in the art.

Another capability that was not previously discussed herein is the ability of user 208 to print, fax, email, instant message, or initiate a peer-to-peer transfer of one or more of shared media objects 202. In an embodiment, user 208 views a particular shared media object that she enjoys, and then prints it directly. If no printer is included in the display, then a command may be sent to a networked printer, e.g., via communication module 210, to print the shared media object. In another embodiment, user 208 views a particular shared media object that he thinks a friend will also enjoy, and then emails it, e.g., via communication module 210, to his friend directly. If printing, faxing, emailing, instant messaging, or initiating a peer-to-peer transfer cannot immediately occur due to a lack of a network connection, then transmission is delayed until a network connection or a means of transferring the command becomes available, at which point the command is carried out. In an embodiment, implicit metadata is generated based on the transmission of the shared media object by user 208. Specifically, the present invention may imply that user 208 found that the shared media object was somehow significant to the recipient of the shared media object. In that case, metadata 204 may additionally include the implicit metadata, and display characteristics 214 may additionally be determined based thereon. For example, if user 208 emails a shared media object to her friend Jane, when user 208's calendar indicates that Jane will be visiting, the shared media object that was sent to Jane may be displayed more often.

An additional capability that was not previously discussed herein is the ability of display module 216 to display other information in addition to and concurrently with shared media objects 202. For example, when a shared media object is being displayed, the average user rating may be displayed at the bottom of the display so that user 208 can view the average user rating at the same time as the shared media object. In another example, the time of day may be displayed in the upper left corner of the display while shared media objects 202 are being displayed. Someone of ordinary skill in the art would understand that there is an infinite selection of information that could be displayed concurrently with shared media objects 202 according to the present invention.

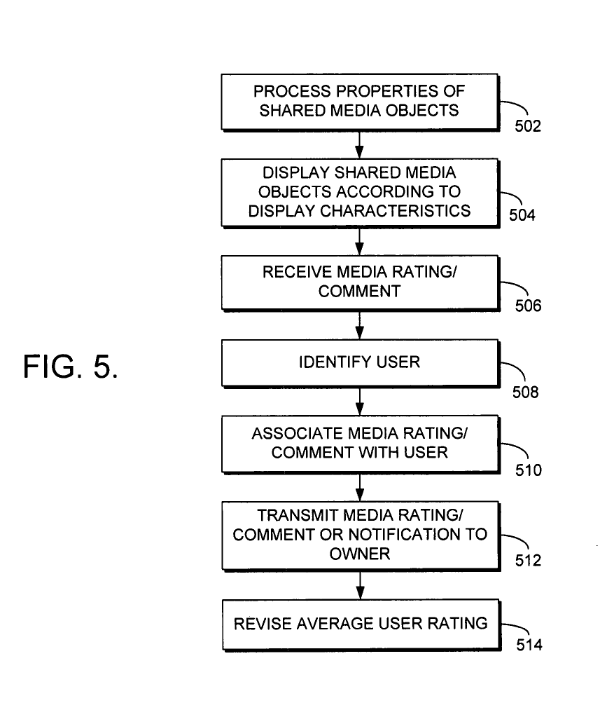

FIG. 5 is a flowchart illustrating the display of media objects and the receipt of reviews/comments, according to embodiments of the present invention. With reference to FIG. 5, metadata 204 of shared media objects 202 are processed (502). Shared media objects 202 are displayed according to display characteristics 214 (504). Media rating 218 or media comment 220 is received by user interface module 224 (506). User 208 is identified by identification module 226 (508). Media rating 218 or media comment 220 is associated with user 208 (510). Media rating 218 or media comment 220 or notification thereof is transmitted to owner 206 (512). An average user rating is revised according to media rating 218 (514). Embodiments of the present invention may include additional operations or may not include certain operations illustrated in FIG. 5.

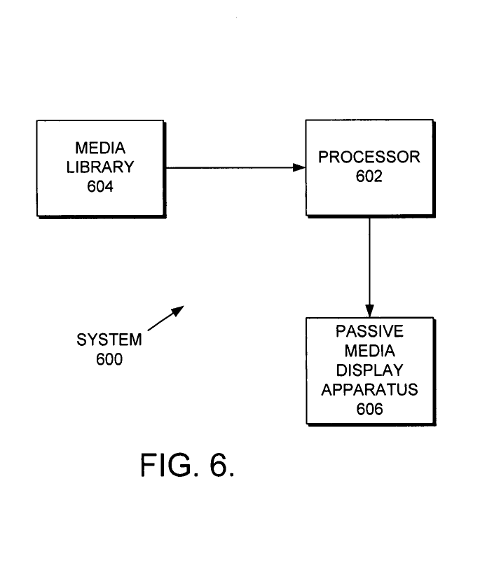

FIG. 6 is a diagram illustrating a system including a passive display apparatus, according to embodiments of the present invention. FIG. 6 illustrates system 600, which comprises processor 602, media library 604, and passive media display apparatus 606. In an embodiment, processor 602 performs the same functions as processing module 212 as described herein. In another embodiment, passive media display apparatus 606 performs the same functions as display module 216 as described herein. Media library 604 stores shared media objects 202 and metadata 204, and may be local or remote in relation to processor 602. For example, processor 602 may be on a PC and media library 604 may be on a web server. Processor 602 and media library 604 are able to communicate via a bus or network connection, but do not necessarily have to be in constant communication. Passive media display apparatus 606 is a passive display such as a television, computer monitor, etc. that does not include the user interface functionality, i.e., ability to receive ratings/comments and identify users, described herein. Passive media display apparatus 606 is connected to processor 602 via a bus or network connection, but does not have to be in constant communication.

In an embodiment, system 600 is implemented as a PC, which houses media library 604 and processor 602, and a CRT monitor that functions as passive media display apparatus 606. Shared media objects 202 are stored in media library 604 (on the PC) and are processed with metadata 204 (on the PC) to determine display characteristics 214. Shared media objects 202 are then displayed on passive media display apparatus 606 (the CRT monitor) according to display characteristics 214. Embodiments of the present invention are not limited to any particular configuration of system 600, as other configurations are possible. For example, a plasma display (passive media display apparatus 606) may be incorporated into a PC that includes processor 602, and media library 604 may be resident on a remotely-accessible hard drive. In an embodiment, media library 604 stores media rating 218 or media comment 220 or both. In another embodiment, media library 604 stores average local rating 308.

Although the present invention has been described with reference to specific exemplary embodiments, it will be evident that various modifications and changes may be made to these embodiments without departing from the broader spirit and scope of the invention. Accordingly, the specification and drawing figures are to be regarded in an illustrative rather than a restrictive sense.

The invention claimed is:

1. A method of displaying media, comprising:
automatically processing metadata of each of a plurality of shared media objects to determine a display characteristic of each of the plurality of shared media objects; and
automatically displaying each of the plurality of shared media objects according to its display characteristic,
wherein the display characteristic is one of order, duration, frequency, transition, and effect.

2. The method of claim 1, wherein a weighting system is used in processing the metadata.

3. The method of claim 1, further comprising:
receiving from a user a media rating of one of the plurality of shared media objects that is displayed or a media comment on one of the plurality of shared media objects that is displayed.

4. The method of claim 3, further comprising:
identifying the user; and
associating the media rating or media comment with the user.

5. The method of claim 3, further comprising:
transmitting the media rating or media comment or a notification of the media rating or media comment to an owner of the shared media object with which the media rating or media comment is associated.

6. The method of claim 3, further comprising:
revising the average user rating based on the media rating.

7. The method of claim 1, further comprising:
additionally processing ambient noise or ambient music to determine the display characteristic of each of the plurality of shared music objects.

8. The method of claim 1, further comprising:
additionally processing a location of display to determine the display characteristic of each of the plurality of shared music objects.

9. The method of claim 1, further comprising:
receiving from a user a command to print, fax, email, instant message, or initiate a peer-to-peer transfer of one of the plurality of shared media objects,
wherein implicit metadata is generated based on a recipient of the shared media object, and
wherein the metadata may be the implicit metadata.

10. A media display apparatus, comprising:
a processing module to automatically determine a display characteristic of each of a plurality of shared media objects based on metadata of each of the plurality of shared media objects; and
a display module to automatically display each of the plurality of shared media objects according to its display characteristic,
wherein the display characteristic is one of order, duration, frequency, transition, and effect.

11. The media display apparatus of claim 10, wherein the processing module comprises a weighting system.

12. The media display apparatus of claim 10, further comprising:
a user interface module to receive from a user a media rating of one of the plurality of shared media objects that is displayed or a media comment on one of the plurality of shared media objects that is displayed.

13. The media display apparatus of claim 12, further comprising:
an identification module to identify the user,
wherein the user interface module associates the media rating or the media comment with the user.

14. The media display apparatus of claim 12, further comprising:
a communication module to transmit the media rating or media comment or a notification of the media rating or media comment to an owner of the shared media object with which the media rating or media comment is associated.

15. The media display apparatus of claim 10, wherein the display characteristic of each of the plurality of shared music objects is additionally based on ambient noise or ambient music.

16. The media display apparatus of claim 10, wherein the display characteristic of each of the plurality of shared music objects is additionally based on a location of the media display apparatus.

17. The media display apparatus of claim 10, further comprising:
a sound module to play music or other audio output.

18. The media display apparatus of claim 10, wherein the display module displays other information in addition to the plurality of shared media objects and concurrently with the plurality of shared media objects.

19. A system for displaying media, comprising:
a media library to store a plurality of shared media objects and metadata of each of the plurality of shared media objects;
a processor to automatically determine a display characteristic of each of the plurality of shared media objects based on the metadata of each of the plurality of shared media objects; and
a passive media display apparatus to automatically display each of the plurality of shared media objects according to its display characteristic,
wherein the display characteristic is one of order, duration, frequency, transition, and effect.

20. The system of claim 19, wherein the display characteristic of each of the plurality of shared music objects is additionally based on ambient noise or ambient music.
